(19) United States
(12) Patent Application Publication
(10) Pub. No.: US 2012/0037739 A1
(43) Pub. Date: Feb. 16, 2012

(54) DEVICE FOR REDUCING PLASTIC

(75) Inventors: Christian Lovranich, Weissenbach/Triesting (AT); Johann Brandstaetter, Furth/Triesting (AT); Andreas Pechhacker, Altenmarkt (AT)

(73) Assignee: STARLINGER & CO GESELLSCHAFT M.B.H, Wein (AT)

(21) Appl. No.: 13/146,914

(22) PCT Filed: Jan. 15, 2010
(86) PCT No.: PCT/EP2010/050439

§ 371 Date: Oct. 17, 2011

(30) Foreign Application Priority Data
Feb. 3, 2009 (AT) A 185/2009

(51) Int. Cl. B02C 18/16

(52) U.S. Cl. 241/277

(57) ABSTRACT

The invention relates to a device (1) for reducing thermal plastic goods (2), comprising a container (3) for receiving the in particular loosely packed plastic goods (2) and a reducing device (4) projecting into the container or arranged therein for reducing the plastic goods and the conveyance thereof to a discharge opening (5), characterized by air inlets (6) in the region of the reducing device and air outlets (7) in the container wall (8).

The invention relates to a device for reducing thermoplastic plastic goods, comprising a container for receiving the in particular loosely packed plastic goods and a reducing device projecting into the container or arranged therein for reducing the plastic goods and the conveyance thereof to a discharge opening.

Plastic waste differs according to its formation and purity. There is made distinction between production and so-called “post consumer” waste, on the one side, and pure, single-variety and mixed, polluted plastic waste.

In the industrial production of plastic products there is accrued scrap, which is formed during the start-up, reorganization or maintenance of plants, until the required product data are achieved, or which is a result of the production method itself, for example as chads or as marginal strips of blown films to be discarded.

Before plastic waste can be conveyed to the recycling process proper, these materials have to be available in pure form. Therefore, these are separated, for example, into the individual fractions polyolefins (as representatives thereof there are to be mentioned polyethylene PE as well as polypropylene PP), polyvinylchloride (PVC) and polystyrene, and adhering foreign matter such as metals or colours are usually removed using physical procedures. The single-variety plastic waste is then usually purified using water and subsequently processed by means of conventional methods of plastics processing. These methods include, for example, extrusion, injection moulding or transfer moulding, intrusion and sinter press methods.

Problems in the processing of the collected plastic waste are the greatly varying operational conditions in connection with the charging of such recycling plants. Hence, there have to be controlled various levels of residual moisture, contamination, density differences and feed portions in order to obtain a homogenous product of constant product quality from a heterogeneous waste.

Wet plastic waste is usually dried in centrifuges, with the centrifugal force substantially accelerating the removal of the liquid adhering to the plastic material. Disadvantageous is therefore, apart from the high energy consumption, the apparent weight increase of the goods to be dried due to the centrifugal force as well as the high compression of the waste material, which subsequently has to be loosened up and further transported using great force effort.

From the state of the art, there is, for example known from the WO 2007/112466 a device for drying plastic particles using a rotating body with a perforated jacket, wherein the space will enlarge from the inlet opening of the moist plastic waste towards the discharge of the material. The plastic waste to be dried is introduced on the front side at the smaller end of the rotating body or the perforated jacket, respectively, wherein the goods are spun in the ring gap existing between the rotating body and the perforated jacket against the internal surface of the perforated jacket. Due to the transport of the moist goods in the direction of an enlarging diameter of the gap between rotating body and jacket, there are obtained better ventilation and, hence, a better drying effect. In a preferred embodiment there is arranged in the inside of the rotating body a blower, for example in the form of a fan rotating around the axis of the rotating body. Thereby, drying the plastic waste in the feed region will be further accelerated. The drying device does not include a reducing device.

This design is disadvantageous insofar as the entire goods to be dried have to be accelerated in the centrifuge using high energy input and will inevitably be compressed. In order to loosen up the plastic waste for enabling further conveyance, the goods finally reach a radial blower at the lower end, which takes up the dried goods and expels them by means of exhaust vents. The radial blower, however, will be under enormous strain, for which reason and also for reducing the noise generated it has to be configured with especially thick walls. In this way, additional heavy masses have to be permanently driven in the blower of this device with a high amount of energy expenditure. Reducing the plastic waste will not be realized or only to a small extent.

DE 92 02 161 introduces a device for reducing empty oil cans made from plastics. In a basic embodiment, there is provided at the bottom of a filling shaft a cutting disc with cutting knives arranged upwards, wherein directly beneath the cutting disc there are arranged a collecting vessel in the form of a colander for the reduced plastic scraps and a collecting tray for the residual oil at the lowest level. Between external case and filling shaft, there is provided a hot air blower connected with the filling shaft by means of at least one opening. The device is discontinuously driven, by filling the filling shaft with empty cans, subsequently the cover of the filling shaft is closed and then the motor for driving the cutting disc is actuated. By cutting and reducing the cans, the volume of the waste batch is greatly reduced, for which reason it is possible to collect several batches of reduced plastic waste together in the collecting tray before this has to be emptied. In a special embodiment, there is in addition provided a rotating screening drum inside the filling shaft spaced apart from the cutting disc, wherein the waste batch is put into rotation in the screening drum and in this way the residual oil is removed more intensely than by simply draining the plastic waste.

The device is disadvantageous insofar as it cannot be operated continuously, as here—comparable with an electric coffee grinder—there has to be closed a cover after a batch of the goods to be reduced has been filled in and before the cutting tool can be actuated. In the simple configuration as well as the in configuration with a rotating screening drum this results in the compression of the reduced plastic scraps as these may only be removed from the collecting tray upon several filling cycles as a collected unity. Furthermore, such an operation is time-consuming and requires increased monitoring and maintenance effort.

A continuous processing of such a pre-processed waste, hence, requires at least one further storage container as a temporary storage for the individual waste batches as well as a suitable device, so that the compressed plastic scraps may then be loosened up again and be conveyed to the subsequent work process steps.

AT 504 854 illustrates a method and a device for processing preferably thermoplastic plastic waste, wherein the device comprises a receiving container, at the bottom of which there is arranged a horizontally rotating carrier disc with mixing and cutting tools attached at its upper side. After being filled in, the waste material is then mixed by these rotating mixing tools in the region of the receiving container and also optionally reduced or heated, respectively. Through a ring gap, situated between the rotating carrier disc and the receiving container, the correspondingly reduced plastic material is slowly moved to the space underneath the rotating carrier disc and is there further reduced or heated, respectively, by means of additional, also horizontally rotating mixing tools. At the same time, the reduced plastic material is conveyed due to the rotational effect of the lower mixing tools into a discharge opening at the circumference of the receiving container and from there on is moved with a screw conveyor to a down-stream situated plastic extruder. In the lower region of the container walls as well as in the region of the mixing tools there are provided openings, through which there is delivered the gas into the receiving container, which is intended to accelerate the drying process of, e.g. water-moist plastic waste in the receiving container.

This device is disadvantageous insofar as during the operation in the region of the receiving container, which is situated above the rotating disc with the mixing tools, there are formed thrombi and hence the moist plastic material is compressed at the external walls of the receiving container. The injected and rising gas can in this region only insufficiently perfuse the moist plastic material, whereby the desired drying process is impeded. Furthermore, it is not possible with this device to guarantee a uniform narrow corn size distribution of the plastic particles, as also bigger, flat plastic waste in the ring gap may pass the mixing tools and directly reach the discharge opening, without having been reduced. This will result in a blocking of the discharge opening through bigger, flat plastic parts and, hence, also operational malfunction. Furthermore, bigger plastic parts and materials that are hard to reduce cannot be reduced using this device without being pre-reduced.

Therefore, there is a demand for improving the disadvantages of the state of the art of such devices, which are able to reduce and also dry plastic waste. There is to be provided a device, which preferably in a continuous operation guarantees efficient drying of moist plastic waste without energy-consuming centrifugation as well as simultaneously reliable reduction thereof so that the pre-processed waste material may then be conveyed directly into an extruder.

The present invention solves this aim by making provision of a device for reducing thermoplastic plastic material, comprising a container for receiving the in particular loosely packed plastic goods and a reducing device projecting into the container or arranged therein for reducing the plastic good and the conveyance thereof to a discharge opening, characterized by air inlets in the region of the reducing device and air outlets in the container wall.

Advantageous configurations of the invention are illustrated in the dependent claims and the specification.

The present invention offers the following advantages over the known state of the art:
The device may be operated completely continuously and low-maintenance and may, hence, be used for drying as well as reducing thermoplastic plastic goods directly upstream of a continuously operating plastic extruder.
Surface moisture as well as moisture hygroscopically absorbed by the material may be dried in the device according to the invention.
An exclusively batch-wise charging with plastic goods is not required with this device.
Manipulation and batch-wise removal of dried and reduced plastic goods is omitted, as the processed plastic goods are continuously conveyed out of the device using a screw conveyor.
Compression of the plastic goods, which, for example, inevitably is the result when spinning off in a centrifuge, is omitted. Here, the moist plastic goods are loosely distributed in the receiving container.
In the device according to the invention there is not required in the region of the receiving container a rotating centrifuge liner, for example a screening tray with associated actuation means. An especially compact configuration of the case with greater wall thicknesses in the region of the receiving container as well as additional safety devices, as required for centrifuges, which prevent spinning out of goods or protect the service staff from being hurt, need not be provided here. The device, hence, may be constructed essentially more cost-effective.
By selecting the air inlets in the region of the reducing device, the plastic goods are dried in the reducing device as well as in the receiving container. Thereby, the formation of condensate inside the entire device is reliably prevented.
The convective flow inside the receiving container, caused by introducing preferably dry, pre-heated air into the reducing device and then further into the receiving container, or the suction of moist air from the receiving container, respectively, achieve faster drying kinetics for the plastic goods loosely distributed therein.
If the plastic goods to be processed have already been compressed before being delivered to the device, they will then be loosened up in the receiving container due to the convective flow prevailing therein.
The configuration characteristic that the air is blown in directly into the region of the reducing device and is therein directed preferably in the same flow direction (in a concurrent flow) as the plastic goods to be conveyed additionally supports the delivery of the plastic goods to the reducing device. The entire plastic goods are then reliably conveyed into the reducing device, before it may then be moved from there to the discharge opening of the device.
The device has such a configuration that only plastic goods that have been taken up by the reducing device at least once and have been further reduced thereby will be moved to the discharge opening of the device and then, for example, into a plastic extruder. In this way, consequential damage such as the obstruction of recycling machines situated downstream is prevented.
Also big plastic parts and materials that are hard to reduce may be processed in one step.

In a preferred embodiment of the invention the device comprises a device for the generation of compressed air, the discharge of which is attached at the air inlets of the device. The aim of the device for the generation of compressed air is to provide compressed air in a sufficient amount in order to generate a convective flow inside the device and thereby achieve the desired drying effect for the moist plastic goods.

Furthermore, the device according to the invention may comprise a steam suction device attached at the air outlets of the device. The moist air or the steam, respectively, are thereby reliably discharged from the device and into the ambiance. In this way, there is prevented the formation of condensate in the device as well as undesired further moistening of the moist plastic goods by the steam otherwise existent inside the container.

The device has the advantage that the device for the generation of compressed air is formed as a lateral channel compressor. Such lateral channel compressors are suitable for all purposes, wherein there is required more pressure than conventional fans are able to generate. The rotating parts of a lateral channel compressor do not contact the case, hence there is no friction and, hence, lubrication is not required. The process of compression is realized without any oil and coal dust, the air will not be polluted.

Preferably the steam suction device is formed as a radial blower.

The device is usefully configured in a way so that the container for receiving the plastic goods is in communication with the surrounding. Due to the above open construction of the container it is possible rather easily to fill the moist plastic goods into the device, for example, by means of a conveyor belt or conveyor shaft. The receiving container may be equipped with a cover lid or the like, in order to prevent the discharge of very light plastic particles from the device. Such a cover lid, however, is provided with at least one opening for delivering the plastic goods.

A device for reducing the plastic goods, which projects into the receiving container of the device or which is arranged therein, comprises a rotating body rotatable around an axis of rotation, which is provided with knives at its circumferential surface, wherein there are arranged preferably in the container near the trajectory of the knives of the rotor body standing knives that exert a shear effect with the knives of the rotor body onto the plastic goods. In addition, there may be provided in the region of the material feed into the reducing device a further packing slider, which is periodically moved forth and back, and in this way there is guaranteed that the plastic goods are taken up by the rotor body equipped with knives, that they are subsequently moved into the gap between the rotor body and the standing knives and are then there further reduced due to shear effect.

In a special embodiment of the device the rotor of the reducing device is surrounded at least in part by a jacket wall, arranged spaced apart from the trajectory of the knives of the rotor body, wherein the air inlets are arranged in the jacket wall. With this embodiment, the gap around the rotor body, starting with the first standing knife and subsequently in the circumferential direction of the rotor body defined by the jacket wall, is further continued, and there is obtained even a longer effect of the shear forces onto the plastic goods and, hence, an even more efficient reduction. The air inlets in the jacket wall provide the reducing device with dry air, which absorbs the still existent residual moisture on the plastic goods within the reducing device and which then rises as moist air or steam, respectively, in the receiving container.

By providing a conveyor device, in particular a dosing screw being attached at the discharge opening of the device, the reduced and dried plastic goods are advantageously continuously discharged from the device. Thereby, the device without puffer container may be directly connected with a processing unit situated downstream, such as, e.g. a continuously operating plastic extruder.

The invention is now described in greater detail by way of an exemplary embodiment, to which the invention, however, is not limited, while referring to the following drawings, wherein:

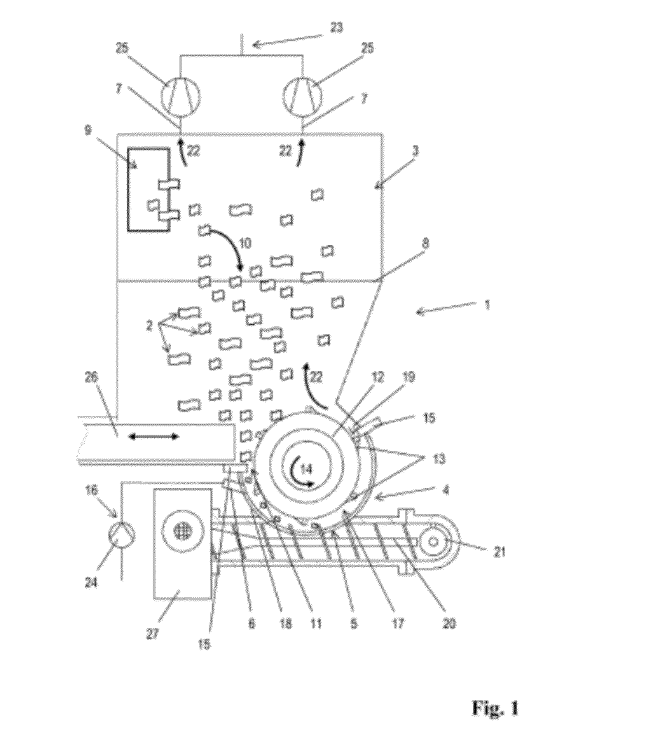

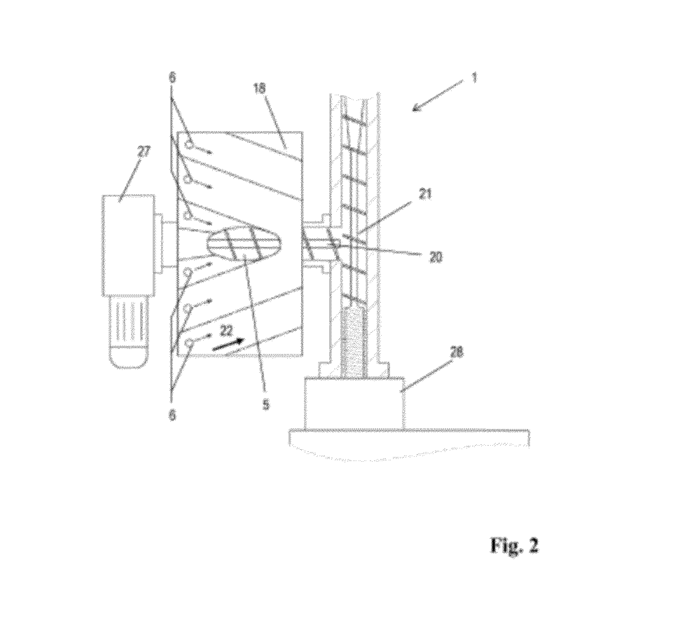

FIG. 1 is a device according to the invention for reducing plastic waste in a schematic sectional lateral view; and FIG. 2 is a detail of the device in the region of the reducing device in a schematic top view.

In FIG. 1, the device 1 for reducing thermoplastic plastic goods 2 is illustrated, comprising a container 3 for receiving the in particular loosely packed plastic goods 2 and a reducing device 4 projecting into the container 3 or arranged therein for reducing the plastic goods and the conveyance thereof to a discharge opening 5, characterized by air inlets 6 in the region of the reducing device 4 and air outlets 7 in the container wall 8.

For a better understanding, the device 1 is illustrated in FIG. 1 in a sectional lateral view, wherein the chosen section plane is situated vertically in the centre of the device 1. Thereby, there is created a view into the inside of the device 1.

The moist plastic goods 2 are moved from the outside, by means of a conveyor belt or another, for example pneumatic, conveyor device not displayed in FIG. 1 and also not integral part of the device 1 according to the invention, through an opening 9 into the container 3 of the device 1. The opening 9 is situated in the region of the container wall 8.

Due to gravity, the moist plastic goods 2 would be moved in the container 3 directly in the direction of arrow 10 downwards to the reducing device 4 and come to a halt densely stacked upon each other. Then there would also be included the residual moisture still adhering to the plastic goods, drying of the plastic goods would be possible only insufficiently. Furthermore, the stacked plastic goods would probably obstruct the gap 11 situated between the rotor body 12 or the knives 13 attached thereon, respectively, wherein the rotor body 12 rotates in the direction of rotation 14, and the standing knives 15; the plastic goods 2, hence, could not be moved into the reducer 4, and a failure-free operation would not be guaranteed.

For this reason, the invention is characterized by air inlets 6 in the region of the reducing device 4, which are displayed as air inlets 6 in the jacket wall 18 in FIG. 1, wherein the air is moved from a device for the generation of compressed air 16 via pipes to the air inlets 6 and is then selectively injected into the gap 17 between the jacket wall 18, arranged spaced apart from the trajectory of the knives 13 of the rotor body 12, and the rotor body 12. In this way, the air, which enters the reducing device 4 preferably in a dry state through the air inlets 6, is moved mainly in the direction of rotation 14 of the rotor body 12 and hence in the conveyance direction of the plastic goods 2, and thereby moisture from the plastic goods 2 is then discharged by a convective flow in the gap 17, and the formation of condensate at the jacket wall 18 as well as the rotor body 12 is prevented.

The device for the generation of compressed air 16 is preferably formed as a lateral channel compressor 24.

The major amount of the injected air flows in the direction of rotation 14 alongside the rotor body 12 through the gap 17 until it reaches, at the opposite discharge gap 18, which again is formed by one or several standing knives 15 and the rotating knives 13 attached on the rotor body 12, the inside of the container 3. A smaller partial flow of the injected air is moved in the opposite direction to the direction of rotation 14 of the rotor body 12 and, hence, in the opposite direction to the conveyance direction of the plastic goods 2 within the reducing device 4, through the gap 11 into the inside of the container 3 and then loosens up, if necessary, any plastic goods 2 present in the region of the gap 11. Another smaller partial flow of the air injected via the air inlets 6 leaves the gap 17 through the discharge opening 5 and is moved, together with the reduced plastic goods, into the dosing screw 20 and then further on into the extruder screw 21, which conveys the plastic goods to the extruder situated downstream and not displayed in FIG. 1.

Inside the container 3 the air rises from the reducing device 4 into the direction of arrow 22 upwards. The flow rate of the air inside the container 3 is selected so that the fed plastic goods 2 will sink downwards to the reducing device 4 with a lower velocity in the counter-flow in the direction of arrow 10, in this way being dried by the rising air flow. Very light or flat plastic particles should not be discharged from the container 3.

There is usefully provided therefore a respective cover lid in the region of the opening 9 for the plastic feed, which is, for example, configured as a fine screen or fleece and which is not adapted to the displayed conveyor device, and which prevents very small plastic particles from being discharged from the device 1 or through a gap between the device 1 and the conveyor device for feeding the plastic goods, respectively. Such a cover lid is not illustrated in FIG. 1.

The moist air or the steam, respectively, is discharged in the upper part of the container 3 via air outlets 7 in the container wall 8 out of the device 1 into the ambiance. In FIG. 1, these air outlets 7 are attached at a steam suction device 23. The steam suction device is preferably configured as a radial blower 25, wherein in FIG. 1 there are illustrated two air outlets 7 each having its own radial blower 25.

Furthermore, there is provided a packing slider 26 in FIG. 1, horizontally in the lower region of the container 3. By using the packing slider 26, which is moved back and forth in the horizontal direction, the plastic goods 2 are reliably delivered to the gap 11. Furthermore, FIG. 1 illustrates the drive 27 of the dosing screw 20.

FIG. 2 illustrates a detail of the device 1 in the region of the reducing device 4 in a schematic top view. Therein, the jacket wall 18, surrounding the rotor body 12 not displayed here, is illustrated comprising several air inlets 6. The arrows 22 indicate the flow direction of the injected air or the transport direction of the reduced plastic goods 2, respectively. The jacket wall 18 may, as shown in FIG. 2, have a profile, for example with grooves or ridges, whereby the plastic goods in the gap 17 are pushed together through the transversely extending grooves or ridges, respectively, in the direction of the centrally arranged discharge opening 5 and are then moved from there to the dosing screw 20. Furthermore, there is displayed in FIG. 2 the drive 27 of the dosing screw 20 as well as the further extruder screw 21 including its drive 28, angularly attached thereto. The two conveyor screws 20 or 21, respectively, are illustrated in horizontal sections for a better understanding.

1. A device for reducing thermoplastic plastic goods, comprising a container for receiving the in particular loosely packed plastic goods and a reducing device projecting into the container or arranged therein for reducing the plastic goods and the conveyance thereof to a discharge opening, characterized by air inlets in the region of the reducing device and air outlets in the container wall.

2. The device according to claim 1, characterized by a device for the generation of compressed air, the discharge of which being attached to the air inlets.

3. The device according to claim 1, characterized by a steam suction device attached to the air outlets.

4. The device according to claim 2, characterized by the fact that the device for the generation of compressed air is formed as a lateral channel compressor and/or the steam suction device as a radial blower.

5. The device according to claim 1, characterized by the fact that the container is in communication with the surrounding.

6. The device according to claim 1, characterized in that the reducing device comprises at least one rotor body rotatable around an axis of rotation, which is equipped at its circumferential surface with knives, wherein there are arranged preferably in the container near the trajectory of the knives of the rotor body standing knives, which exert a shear effect with the knives of the rotor body onto the plastic goods.

7. The device according to claim 6, characterized by a jacket wall surrounding at least in part the rotor body, which is arranged spaced apart from the trajectory of the knives of the rotor body, wherein the air inlets are arranged in the jacket wall.

8. The device according to claim 1, characterized in that there is attached at the discharge opening a conveyor device for the reduced plastic goods, in particular a dosing screw.
